(19) United States
(12) Patent Application Publication
(10) Pub. No.: US 2024/0047637 A1
(43) Pub. Date: Feb. 8, 2024

(54) NEGATIVE ELECTRODE AND METHOD FOR MANUFACTURING THE SAME

(71) Applicant: LG ENERGY SOLUTION, LTD., Seoul (KR)

(72) Inventors: Taek-Soo LEE, Daejeon (KR); Shin-Wook JEON, Daejeon (KR); Sang-Hoon CHOY, Daejeon (KR)

(73) Assignee: LG ENERGY SOLUTION, LTD., Seoul (KR)

(21) Appl. No.: 18/266,739

(22) PCT Filed: Dec. 28, 2021
(86) PCT No.: PCT/KR2021/020085

§ 371 Date: Jun. 12, 2023

(30) Foreign Application Priority Data
Dec. 28, 2020 (KR) 10-2020-0185309

(51) Int. Cl. H01M 4/04; H01M 10/052; H01M 4/62

(52) U.S. Cl. CPC H01M 4/0404; H01M 10/052; H01M 4/621; H01M 2004/027

(57) ABSTRACT

Disclosed are a negative electrode, a method for manufacturing the negative electrode, and a lithium secondary battery including the negative electrode. The negative electrode includes a negative electrode current collector; and a negative electrode active material layer disposed on at least one surface of the negative electrode current collector, and having a lower layer region containing a first active material and a first binder, and an upper layer region disposed on the lower layer region and containing a second active material and a second binder, wherein the weight percentage (wt %) of the binder polymer in the lower layer region is larger than the weight percentage (wt %) of the binder polymer in the upper layer region, the lower layer region and the upper layer region have a thickness ratio of 1:1.04-1:9, and the lower layer region and the upper layer region have a weight ratio of 1:1.04-1:9.

### TECHNICAL FIELD

The present disclosure relates to a negative electrode having improved adhesion and a method for manufacturing the same.

The present application claims priority to Korean Patent Application No. 10-2020-0185309 filed on Dec. 28, 2020 in the Republic of Korea, the disclosures of which are incorporated herein by reference.

### BACKGROUND ART

As technical development and needs for mobile instruments have been increased, rechargeable secondary batteries that can be downsized and provided with high capacity have been increasingly in demand. In addition, among such secondary batteries, lithium secondary batteries having high energy density and operating voltage have been commercialized and used widely.

A lithium secondary battery has a structure including an electrode assembly having a positive electrode and a negative electrode, each of which includes an active material coated on an electrode current collector, and a porous separator interposed between both electrodes; and a lithium salt-containing electrolyte injected to the electrode assembly. The electrode is obtained by applying a slurry including an active material, a binder and a conductive material dispersed in a solvent to a current collector, followed by drying and pressing.

In the case of the conventional commercialized battery, each of the negative electrode and positive electrode is formed by coating each electrode slurry once to each electrode current collector. In this case, when determining the binder distribution of the sectional surface of each electrode, the binder content is high in the vicinity of the surface, but is reduced toward the current collector.

Thus, the electrode shows low binding force due to a decrease in binder content in the vicinity of the current collector. When increasing the binder content to solve such a problem of degradation of adhesion, electrical resistance is increased to cause the problem of a decrease in capacity.

### DISCLOSURE

### Technical Problem

The present disclosure is designed to solve the problems of the related art, and therefore the present disclosure is directed to providing a negative electrode having improved adhesion and a method for manufacturing the same.

The present disclosure is also directed to providing a lithium secondary battery including the negative electrode.

### Technical Solution

In one aspect of the present disclosure, there is provided a negative electrode according to any one of the following embodiments.

According to the first embodiment, there is provided a negative electrode, including:
a negative electrode current collector; and
a negative electrode active material layer disposed on at least one surface of the negative electrode current collector, and having a lower layer region containing a first active material and a first binder, and an upper layer region disposed on the lower layer region and containing a second active material and a second binder,
wherein the weight percentage (wt %) of the binder polymer in the lower layer region is larger than the weight percentage (wt %) of the binder polymer in the upper layer region,
the lower layer region and the upper layer region have a thickness ratio of 1:1.04-1:9, and
the lower layer region and the upper layer region have a weight ratio of 1:1.04-1:9.

According to the second embodiment, there is provided the negative electrode as defined in the first embodiment, wherein the lower layer region and the upper layer region have a thickness ratio of 1:1.65-1:8.96.

According to the third embodiment, there is provided the negative electrode as defined in the first or the second embodiment, wherein the lower layer region and the upper layer region have a weight ratio of 1:1.65-1:9.

According to the fourth embodiment, there is provided the negative electrode as defined in any one of the first to the third embodiments, wherein the ratio of the weight percentage (wt %) of the first binder in the lower layer region based on the weight percentage (wt %) of the second binder in the upper layer region is 1.1-20.

According to the fifth embodiment, there is provided the negative electrode as defined in any one of the first to the fourth embodiments, wherein each of the first active material and the second active material includes artificial graphite, natural graphite, hard carbon, soft carbon, graphitized carbon fibers, graphitized mesocarbon microbeads, petroleum cokes, baked resin, carbon fibers, pyrolyzed carbon, Si, silicon oxide represented by SiOₓ (0<x≤2), lithium titanium oxide (LTO), lithium metal, or two or more of them.

In another aspect of the present disclosure, there is provided a method for manufacturing a negative electrode according to any one of the following embodiments.

According to the sixth embodiment, there is provided a method for manufacturing a negative electrode, including the steps of.
preparing a slurry for a lower layer containing a first active material, a first binder and a first dispersion medium, and a slurry for an upper layer containing a second active material, a second binder and a second dispersion medium;
coating the slurry for a lower layer on one surface of a negative electrode current collector, and coating the slurry for an upper layer on the coated slurry for a lower layer, at the same time or with a predetermined time interval; and
drying the coated slurry for a lower layer and the coated slurry for an upper layer at the same time to form an active material layer,
wherein the weight percentage (wt %) of the first binder polymer in the solid content of the slurry for a lower layer is larger than the weight percentage (wt %) of the second binder polymer in the solid content of the slurry for an upper layer,
the coated slurry for a lower layer and the coated slurry for an upper layer have a thickness ratio of 1:1.04-1:9, and
the solid content of the coated slurry for a lower layer and the content of the coated slurry for an upper layer have a weight ratio of 1:1.04-1:9.

According to the seventh embodiment, there is provided the method for manufacturing a negative electrode as defined in the sixth embodiment, wherein the coated slurry for a lower layer and the coated slurry for an upper layer have a thickness ratio of 1:1.65-1:8.96.

According to the eighth embodiment, there is provided the method for manufacturing a negative electrode as defined in the sixth or the seventh embodiment, wherein the solid content of the coated slurry for a lower layer and the sold content of the coated slurry for an upper layer have a weight ratio of 1:1.65-1:9.

According to the ninth embodiment, there is provided the negative electrode as defined in any one of the sixth to the eighth embodiments, wherein the ratio of the weight percentage (wt %) of the first binder in the solid content of the coated slurry for a lower layer based on the weight percentage (wt %) of the second binder in the solid content of the coated slurry for an upper layer is 1.1-20.

According to the tenth embodiment, there is provided a lithium secondary battery including the negative electrode as defined in any one of the first to the fifth embodiments.

### Advantageous Effects

According to an embodiment of the present disclosure, it is possible to increase the binding force between an active material layer and a current collector, while not significantly increasing the content of a binder, to prevent separation of the active material, and to provide a negative electrode with improved resistance characteristics.

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

In one aspect of the present disclosure, there is provided a negative electrode, including:
a negative electrode current collector; and
a negative electrode active material layer disposed on at least one surface of the negative electrode current collector, and having a lower layer region containing a first active material and a first binder, and an upper layer region disposed on the lower layer region and containing a second active material and a second binder,
wherein the weight percentage (wt %) of the binder polymer in the lower layer region is larger than the weight percentage (wt %) of the binder polymer in the upper layer region,
the lower layer region and the upper layer region have a thickness ratio of 1:1.04-1:9, and
the lower layer region and the upper layer region have a weight ratio of 1:1.04-1:9.

According to an embodiment of the present disclosure, each active material of the active material layer, i.e. each of the first active material and the second active material may be any negative electrode active material, as long as it is one used conventionally. For example, each of the first active material and the second active material may include independently include, but is not limited to, a carbonaceous active material, a silicon-based active material, or the like. Particular examples of each active material include, but are not limited to: artificial graphite, natural graphite, hard carbon, soft carbon, graphitized carbon fibers, graphitized mesocarbon microbeads, petroleum cokes, baked resin, carbon fibers, pyrolyzed carbon, Si, silicon oxide represented by SiOₓ (0<x≤2), lithium titanium oxide (LTO), lithium metal, or two or more of them.

Herein, in general, artificial graphite may be prepared through carbonization of raw materials, such as coal tar, coal tar pitch and petroleum-based heavy oil, at a temperature of 2,500° C. or higher. After such graphitization, the resultant product is subjected to particle size adjustment, such as pulverization and secondary particle formation, so that it may be used as a negative electrode active material. In the case of artificial graphite, it includes crystals distributed randomly in particles and has a lower sphericity as compared to natural graphite and a slightly sharp shape.

The artificial graphite used according to an embodiment of the present disclosure includes commercially available mesophase carbon microbeads (MCMB), mesophase pitch-based carbon fibers (MPCF), block-like graphitized artificial graphite, powder-like graphitized artificial graphite, or the like, and may be artificial graphite having a sphericity of 0.91 or less, preferably 0.6-0.91, and more preferably 0.7-0.9.

As used herein, ‘sphericity’ may be a value obtained by projecting a graphite-based active material, and dividing the circumference of a circle having the same area as the projected image of the graphite-based active material by the circumferential length of the projected image. Particularly, the sphericity may be represented by the following Mathematical Formula 1. The sphericity may be determined by using a particle shape analyzer, such as a particle shape analyzer, including sysmex FPIA3000 available from Malvern Co.

Sphericity=Circumference of circle having the same area as projected image of active material/Circumferential length of projected image [Mathematical Formula 1]

In addition, the artificial graphite may have a particle diameter of 5-30 μm, preferably 10-25 μm.

In general, natural graphite is in the form of a sheet-like aggregate before processing, and sheet-like particles are formed into spherical shapes having smooth surfaces through a post-treatment process, such as particle pulverization and regranulation, so that they may be used as active materials for manufacturing an electrode.

The natural graphite used according to an embodiment of the present disclosure may have a sphericity of larger than 0.91 and equal to or less than 0.97, preferably 0.93-0.97, and more preferably 0.94-0.96.

The natural graphite may have a particle diameter of 5-30 μm, preferably 10-25 μm.

The active material layer may include two or more types of active materials. In this case, different types of active materials may be distributed from the vicinity of the current collector of the active material layer toward the surface, or two or more active materials which are homogeneous but are different in terms of average particle diameter or shape may be present. Further, two or more different types of active materials having different in shape or average particle diameter may be used in the active material layer.

For example, the active material layer may include natural graphite alone or a mixture of natural graphite with artificial graphite, in the lower layer region in the vicinity of the current collector, and may include artificial graphite alone or a mixture of natural graphite with artificial graphite, or an active material having a different type or combination from the lower layer region, in the upper layer region in the vicinity of the surface. In addition, even when the active material layer includes a homogeneous active material (e.g. a mixture of natural graphite with artificial graphite), the lower layer region may include an active material having a smaller average particle diameter, and the upper layer region may include an active material having a larger average particle diameter.

When the lower layer region and the upper layer region of the active material layer include different types of active materials or active materials different in average particle diameter or shape as mentioned above, an intermixing region may be present at the portion where the lower layer region is in contact with the upper layer region, wherein different types of active materials exist in combination in the intermixing region.

According to an embodiment of the present disclosure, when the upper layer region of the active material layer includes a mixture of artificial graphite with natural graphite, the weight ratio of artificial graphite to natural graphite may be 9.99:0.01-0.01:9.99, particularly 9.7:0.3-7:3. When the above-defined weight ratio is satisfied, it is possible to realize a higher output.

In addition, when the lower layer region of the active material layer includes a mixture of artificial graphite with natural graphite, the weight ratio of artificial graphite to natural graphite may be 9.99:0.01-0.01:9.99, particularly 9.5:0.5-6:4. When the above-defined weight ratio is satisfied, it is possible to realize a higher output even at the same content of conductive material.

According to the present disclosure, the lower layer region derived from the slurry for a lower layer and the upper layer region derived from the slurry for an upper layer may have a thickness ratio of 1:1.04-1:9. For example, the thickness ratio may be 1:1.65-1:8.96, 1:1.653-1:8.95, or 1:3.738-1:8.95, or 1:1.04 or more, 1:1.65 or more, 1:1.653 or more, 1:3.738 or more, 1:8.95 or more, 1:8.96 or more, 1:9 or less, 1:8.96 or less, 1:8.95 or less, 1:3.738 or less, or 1:1.653 or less.

According to an embodiment of the present disclosure, the thickness ratio of the lower layer region to the upper layer region may vary with the method for forming the negative electrode active material layer. For example, the method for forming the negative electrode active material layer may include a wet-on-dry process or wet-on-wet process. The wet-on-dry process includes applying a slurry for a lower layer of the negative electrode active material layer onto the current collector, followed by drying, to form a lower layer of the active material layer, and applying a slurry for an upper layer onto the lower layer of the active material layer, followed by drying, to form an upper layer. The wet-on-wet process includes applying a slurry for a lower layer of the negative electrode active material layer onto the current collector, applying a slurry for an upper layer onto the slurry for a lower layer at the same time or with a predetermined time interval, and drying the slurry for a lower layer and the slurry for an upper layer at the same time to form a lower layer and an upper layer of the active material layer.

Herein, the thickness ratio of the lower layer region to the upper layer region of the negative electrode active material layer obtained by the wet-on-dry process may be obtained by measuring the thickness of the lower layer of the active material layer formed first to determine the lower layer region thickness, and then subtracting the lower layer thickness from the thickness of the finished negative electrode active material layer to determine the upper layer region thickness.

In addition, the thickness ratio of the lower layer region to the upper layer region of the negative electrode active material layer obtained by the wet-on-wet process may be obtained by applying a slurry for a lower layer used for the corresponding method onto a separate current collector, followed by drying, to form an active material layer, measuring the thickness of the active material layer to determine the lower layer region thickness, and then subtracting the determined lower layer thickness from the total thickness of the negative electrode active material layer obtained by the wet-on-wet process to determine the upper layer region thickness.

According to an embodiment of the present disclosure, the total thickness of the negative electrode active material layer is not particularly limited. For example, the negative electrode active material layer may have a total thickness of 40-300 μm. In addition, the lower layer region in the active material layer may have a thickness of 4-147.06 μm, or 20-75 μm, and the upper layer region may have a thickness of 20.39-270 μm, or 124-179 μm.

When the thickness ratio of the lower layer region to the upper layer region satisfies the above-defined range, it is possible to increase the binding force between an active material layer and a current collector, while not significantly increasing the content of a binder, to prevent separation of the active material, and to provide a negative electrode with improved resistance characteristics.

In the active material layer of the negative electrode according to the present disclosure, the weight ratio (weight ratio per unit area, loading amount ratio) of the lower layer region to the upper layer region may be 1:1.04-1:9. According to an embodiment of the present disclosure, the thickness ratio of the lower layer region to the upper layer region may be 1:1.65-1:9, 1:1.67-1:9, 1:3-1:9, 1:3.71-1:9, or 1:7-1:9, or 1:1.04 or more, 1:1.65 or more, 1:1.67 or more, 1:3 or more, 1:3.71 or more, 1:7 or more, 1:9 or less, 1:7 or less, 1:3.71 or less, 1:3 or less, or 1:1.67 or less.

Herein, when the weight ratio of the lower layer region to the upper layer region satisfies the above-defined range, it is possible to increase the binding force between an active material layer and a current collector, while not significantly increasing the content of a binder, to prevent separation of the active material, and to provide a negative electrode with improved resistance characteristics.

The ratio of the weight percentage (wt %) of the first binder in the lower layer region based on the weight percentage (wt %) of the second binder in the upper layer region, i.e. (wt % of the first binder in the lower layer region)/(wt % of the second binder in the upper layer region) may be 1.1-20, 1.2-15, 1.5-10, or 1.5-2.2.

Herein, when the ratio of the weight percentage (wt %) of the first binder in the lower layer region based on the weight percentage (wt %) of the second binder in the upper layer region satisfies the above-defined range, it is possible to increase the binding force between an active material layer and a current collector, while not significantly increasing the content of a binder, to prevent separation of the active material, and to provide a negative electrode with improved resistance characteristics.

According to an embodiment of the present disclosure, the negative electrode current collector used as a substrate for forming the active material layer is not particularly limited, as long as it has conductivity, while not causing any chemical change in the corresponding battery. For example, copper, stainless steel, aluminum, nickel, titanium, baked carbon, copper or stainless steel surface-treated with carbon, nickel, titanium, silver, etc., aluminum-cadmium alloy, or the like, may be used.

Although the current collector is not particularly limited in its thickness, it may have a currently used thickness of 3-500 μm.

Each of the first binder and the second binder may independently include polyvinylidene fluoride-co-hexafluoropropylene (PVDF-co-HFP), polyvinylidene fluoride, polyacrylonitrile, polymethyl methacrylate, polyacrylic acid, polymethacrylic acid, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, styrene butadiene rubber (SBR), fluoro-rubber, or two or more of them. Herein, each of the first binder and the second binder may use a single type of polymer or two or more types of polymers.

According to an embodiment of the present disclosure, each of the first binder and the second binder may include styrene butadiene rubber (SBR) in combination with carboxymethyl cellulose (CMC).

In the first binder and the second binder, the polymer functioning to contribute to stabilization of slurry dispersion by increasing the viscosity of the slurry may also be referred to as a thickener.

In the first binder and the second binder, the polymer functioning as such a thickener may include carboxymethyl cellulose, starch, polyacrylic acid, polymethacrylic acid, polyvinyl alcohol, or the like.

Such thickeners may be classified into those (e.g. polyacrylic acid, polymethacrylic acid and polyvinyl alcohol) functioning not only as a binder in the active material layer but also as a thickener for stabilizing slurry dispersion, when being used alone, and those (e.g. carboxymethyl cellulose and starch) used in combination with another binder and mostly contributing to stabilization of slurry dispersion.

The method for differentiating a thickener contributing to stabilization of slurry dispersion among the thickeners includes preparing a solution by dissolving each of multiple binders in a solvent at the same content, and determining the binder used for a solution having a relatively higher viscosity as a binder also functioning as a thickener, as compared to the binder used for a solution having a relatively lower viscosity.

In a variant, when preparing a solution of a dispersion medium and a binder used for slurry at the same concentration as the slurry, and the solution shows a viscosity increased above a predetermined viscosity value, the binder may be classified as a binder also functioning as a thickener.

The active material layer may optionally further include a conductive material. The conductive material is not particularly limited, as long as it causes no chemical change in the corresponding battery and has conductivity. Particular examples of the conductive material include: carbon black, such as carbon black, acetylene black, Ketjen black, channel black, furnace black, lamp black or thermal black; conductive fibers, such as carbon fibers or metallic fibers; metal powder, such as fluorocarbon, aluminum or nickel powder; conductive whisker, such as zinc oxide or potassium titanate; conductive metal oxide, such as titanium oxide; conductive materials, such as polyphenylene derivatives, or the like.

In another aspect of the present disclosure, there is provided a method for manufacturing a negative electrode, including the steps of:
preparing a slurry for a lower layer containing a first active material, a first binder and a first dispersion medium, and a slurry for an upper layer containing a second active material, a second binder and a second dispersion medium;
coating the slurry for a lower layer on one surface of a negative electrode current collector, and coating the slurry for an upper layer on the coated slurry for a lower layer, at the same time or with a predetermined time interval; and
drying the coated slurry for a lower layer and the coated slurry for an upper layer at the same time to form an active material layer,
wherein the weight percentage (wt %) of the first binder polymer in the solid content of the slurry for a lower layer is larger than the weight percentage (wt %) of the second binder polymer in the solid content of the slurry for an upper layer,
the coated slurry for a lower layer and the coated slurry for an upper layer have a thickness ratio of 1:1.04-1:9, and
the solid content of the coated slurry for a lower layer and the solid content of the coated slurry for an upper layer have a weight ratio of 1:1.04-1:9.

The active material (the first active material, the second active material) and the binder (the first binder, the second binder) contained in the slurry for a lower layer and the slurry for an upper layer are the same as described above.

The dispersion medium, i.e. each of the first dispersion medium and the second dispersion medium may independently include N-methyl pyrrolidone, acetone, water, or the like.

Herein, the lower layer region of the negative electrode active material layer according to the present disclosure is formed from the coated slurry for a lower layer, and the upper layer region of the negative electrode active material layer according to the present disclosure is formed from the coated slurry for an upper layer.

According to an embodiment of the present disclosure, the slurry for a lower layer is coated, and the slurry for an upper layer may be coated on the slurry for a lower layer at the same time or with a predetermined time interval. According to an embodiment of the present disclosure, the time interval may be 0.6 sec. or less, 0.02-0.6 sec., 0.02-0.06 sec., or 0.02-0.03 sec. Such a time interval generated between the coating of the slurry for a lower layer and the coting of the slurry for an upper layer results from a coating instrument. It is more preferred that the slurry for a lower layer and the slurry for an upper layer are coated at the same time. The slurry for an upper layer may be coated on the slurry for a lower layer by using a coating device, such as a double slot die.

In the step of forming the active material layer, the method may further include a step of pressing the active material layer after the drying step. Herein, the pressing may be carried out by using a method, such as roll pressing, used conventionally in the art, for example, under a pressure of 1-20 MPa at a temperature of 15-30° C.

According to the present disclosure, the coated slurry for a lower layer and the coated slurry for an upper layer may have a thickness ratio of 1:1.04-1:9. According to an embodiment of the present disclosure, the thickness ratio may be 1:1.65-1:8.96, 1:1.653-1:8.95, or 1:3.672-1:8.96, or 1:1.65 or more, 1:2.99 or more, 1:3.67 or more, 1:6.97 or more, 1:8.96 or less, 1:6.97 or less, 1:3.67 or less, or 1:2.99 or less.

Herein, the thickness of the coated slurry for a lower layer and that of the coated slurry for an upper layer may be controlled through the rpm of the flow pump of a slot die, speed of a coating roll, coating gap (gap between each die end and a substrate), or the like. The thickness ratio may be controlled through the rpm of the flow pump and coating gap.

According to an embodiment of the present disclosure, the coated slurry for a lower layer may have a thickness of 4-147.1 μm, or 20-75 μm, and the thickness of the coated slurry for an upper layer may have a thickness of 20.4-270 μm, or 124-179 μm.

Herein, when the thickness ratio of the coated slurry for a lower layer to the coated slurry for an upper layer satisfies the above-defined range, it is possible to increase the binding force between an active material layer and a current collector, while not significantly increasing the content of a binder, to prevent separation of the active material, and to provide a negative electrode with improved resistance characteristics.

According to the present disclosure, the weight ratio of the solid content of the coated slurry for a lower layer to the solid content of the coated slurry for an upper layer may be 1:1.04-1:9. According to an embodiment of the present disclosure, the weight ratio may be 1:1.65-1:9, 1:1.666-1:9, 1:3-1:9, or 1:3.705-1:9.

Herein, when the weight ratio of the solid content of the coated slurry for a lower layer to the solid content of the coated slurry for an upper layer satisfies the above-defined range, it is possible to increase the binding force between an active material layer and a current collector, while not significantly increasing the content of a binder, to prevent separation of the active material, and to provide a negative electrode with improved resistance characteristics.

The ratio of the weight percentage (wt %) of the first binder in the solid content of the coated slurry for a lower layer region based on the weight percentage (wt %) of the second binder in the solid content of the coated slurry for an upper layer region, i.e. (wt % of the first binder in the solid content of the coated slurry for a lower layer region)/(wt % of the second binder in the solid content of the coated slurry for an upper layer region) may be 1.1-20, 1.2-15, 1.5-10, or 1.5-2.2.

Herein, when the ratio of the weight percentage (wt %) of the first binder in the solid content of the coated slurry for a lower layer region based on the weight percentage (wt %) of the second binder in the solid content of the coated slurry for an upper layer region satisfies the above-defined range, it is possible to increase the binding force between an active material layer and a current collector, while not significantly increasing the content of a binder, to prevent separation of the active material, and to provide a negative electrode with improved resistance characteristics.

In still another aspect of the present disclosure, there is provided a lithium secondary battery including the negative electrode obtained as described above. Particularly, the lithium secondary battery may be obtained by injecting a lithium salt-containing electrolyte to an electrode assembly including a positive electrode, the negative electrode as described above and a separator interposed between both electrodes.

The positive electrode may be obtained by mixing a positive electrode active material, a conductive material, a binder and a solvent to form a slurry, and coating the slurry directly onto a metal current collector, or casting the slurry onto a separate support, peeling a positive electrode active material film from the support and laminating the film on a metal current collector.

The positive electrode active material used in the positive electrode active material layer may be any one active material particle selected from the group consisting of LiCoO₂, LiNiO₂, LiMn₂O₄, LiCoPO₄, LiFePO₄ and LiNi_{1-x-y-z}CoₓM1_{y}M2_{z}O₂ (wherein each of M1 and M2 independently represents any one selected from the group consisting of Al, Ni, Co, Fe, Mn, V, Cr, Ti, W, Ta, Mg and Mo, each of x, y and z independently represents the atomic ratio of an element forming oxide, and 0≤x<0.5, 0≤y<0.5, 0≤z<0.5, and 0<x+y+z≤1), or a mixture of at least two of them.

Meanwhile, the same conductive material, binder and solvent as used for manufacturing the negative electrode may be used.

The separator may be a conventional porous polymer film used conventionally as a separator. For example, the porous polymer film may be a porous polymer film made of a polyolefinic polymer, such as ethylene homopolymer, propylene homopolymer, ethylene-butene copolymer, ethylene/hexene copolymer or ethylene/methacrylate copolymer. Such a porous polymer film may be used alone or in the form of a laminate. In addition, an insulating thin film having high ion permeability and mechanical strength may be used. The separator may include a safety reinforced separator (SRS) including a ceramic material coated on the surface of the separator to a small thickness. In addition, a conventional porous non-woven web, such as non-woven web made of high-melting point glass fibers or polyethylene terephthalate fibers, may be used, but the scope of the present disclosure is not limited thereto.

The electrolyte includes a lithium salt as an electrolyte salt and an organic solvent for dissolving the lithium salt.

Any lithium salt used conventionally for an electrolyte for a secondary battery may be used without particular limitation. For example, the anion of the lithium salt may be any one selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

The organic solvent contained in the electrolyte may be any organic solvent used conventionally without particular limitation. Typical examples of the organic solvent include at least one selected from the group consisting of propylene carbonate, ethylene carbonate, diethyl carbonate, dimethyl carbonate, ethyl methyl carbonate, methyl propyl carbonate, dipropyl carbonate, dimethyl sulfoxide, acetonitrile, dimethoxyethane, diethoxyethane, vinylene carbonate, sulforan, gamma-butyrolactone, propylene sulfite, and tetrahydrofuran.

Particularly, among the carbonate-based organic solvents, ethylene carbonate and propylene carbonate, which are cyclic carbonates, are organic solvents having high viscosity and a high dielectric constant, and thus may be used preferably, since they can dissociate the lithium salt in the electrolyte with ease. When such a cyclic carbonate is used after mixing it with a linear carbonate having low viscosity and a low dielectric constant, such as dimethyl carbonate or diethyl carbonate, it is possible to prepare an electrolyte having higher electrical conductivity, more preferably.

Optionally, the electrolyte used according to the present disclosure may further include additives contained in the conventional electrolyte, such as an overcharge-preventing agent, or the like.

The lithium secondary battery according to an embodiment of the present disclosure may be obtained by interposing the separator between the positive electrode and the negative electrode to form an electrode assembly, introducing the electrode assembly to a pouch, a cylindrical battery casing or a prismatic battery casing, and then injecting the electrolyte thereto to finish a secondary battery. In a variant, the lithium secondary battery may be obtained by stacking the electrode assemblies, impregnating the stack with the electrolyte, and introducing the resultant product to a battery casing, followed by sealing.

According to an embodiment of the present disclosure, the lithium secondary battery may be a stacked, wound, stacked and folded or cable type battery.

The lithium secondary battery according to the present disclosure may be used for a battery cell used as a power source for a compact device, and may be used preferably as a unit battery for a medium- or large-size battery module including a plurality of battery cells. Particular examples of such medium- or large-size devices include electric vehicles, hybrid electric vehicles, plug-in hybrid electric vehicles, power storage systems, or the like. Particularly, the lithium secondary battery may be useful for batteries for hybrid electric vehicles and new & renewable energy storage batteries, requiring high output.

### MODE FOR DISCLOSURE

Examples will be described more fully hereinafter so that the present disclosure can be understood with ease. The following examples may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art.

### Example 1: Manufacture of Negative Electrode and Lithium Secondary Battery

<Manufacture of Negative Electrode>

First, 9.45 parts by weight of natural graphite having an average sphericity of 0.95 and 85.05 parts by weight of artificial graphite having an average sphericity of 0.9, as a first negative electrode active material, 1.0 parts by weight of carbon black as a conductive material, 3 parts by weight of styrene butadiene rubber (SBR) and 1.5 parts by weight of carboxymethyl cellulose (CMC), as a first binder, and water as a first dispersion medium were mixed to prepare a slurry for a lower layer having a solid content of 46.0%.

Next, 9.60 parts by weight of natural graphite having an average sphericity of 0.95 and 86.40 parts by weight of artificial graphite having an average sphericity of 0.9, as a second negative electrode active material, 1.0 parts by weight of carbon black as a conductive material, 1.5 parts by weight of styrene butadiene rubber (SBR) and 1.5 parts by weight of carboxymethyl cellulose (CMC), as a second binder, and water as a second dispersion medium were mixed to prepare a slurry for an upper layer having a solid content of 46.0%.

The slurry for a lower layer was coated on one surface of copper (Cu) foil as a negative electrode current collector having a thickness of 10 μm, and the slurry for an upper layer was coated on the slurry for a lower layer at the same time, by using a double slot die.

Then, the coated slurry for a lower layer and the coated slurry for an upper layer were dried at the same time by using a drying system provided with a hot air oven to form an active material layer including a lower layer region disposed on one surface of the negative electrode current collector and an upper layer region disposed on the lower layer region. Herein, the drying chamber of the drying system has ten drying zones from the first drying zone, where the slurry-coated current collector is introduced to the drying system for the first time, to the tenth drying zone. The formed upper and lower active material layers are pressed by roll pressing at the same time to obtain a negative electrode provided with an active material layer having a bilayer structure of upper layer/lower layer.

The hot air temperature condition of each of the first drying zone to the tenth drying zone of the drying system is shown in the following Table 1.

TABLE 1
Hot air temperature (° C.)

| First | Second | Third | Fourth | Fifth | Sixth | Seventh | Eighth | Ninth | Tenth |
|---|---|---|---|---|---|---|---|---|---|
| drying | drying | drying | drying | drying | drying | drying | Drying | drying | drying |
| zone | zone | zone | zone | zone | zone | zone | zone | zone | zone |
| 130 | 110 | 70 | 70 | 70 | 70 | 70 | 70 | 60 | 50 |

Herein, the thickness ratio of the lower layer region to the upper layer region of the negative electrode active material layer, and the weight ratio (loading amount ratio) of the lower layer region to the upper layer region are shown in the following Table 2.

<Manufacture of Positive Electrode>

Li(Ni_{0.6}Mn_{0.2}Co_{0.2})O₂ (NCM-622) as a positive electrode active material, carbon black as a conductive material and polyvinylidene fluoride (PVDF) as a binder were added to N-methyl pyrrolidone (NMP) as a solvent at a weight ratio of 96:2:2 to prepare a positive electrode active material slurry. The slurry was coated on one surface of an aluminum current collector having a thickness of 15 μm, and then dried and pressed under the same conditions as the negative electrode to obtain a positive electrode. Herein, the loading amount of the positive electrode active material layer was 28.1 g/cm² on the dry weight basis.

<Manufacture of Lithium Secondary Battery>

A non-aqueous electrolyte was prepared by dissolving LiPF₆ in an organic solvent containing ethylene carbonate (EC), dimethyl carbonate (DMC) and diethyl carbonate (DEC) mixed at a volume ratio of 1:2:1 to a concentration of 1.0 M.

Then, a polyolefin separator was interposed between the positive electrode and the negative electrode obtained as described above, the resultant structure was received in a pouch cell, and the electrolyte was injected thereto to obtain a lithium secondary battery.

### Example 2: Manufacture of Negative Electrode and Lithium Secondary Battery

A negative electrode and a lithium secondary battery were obtained in the same manner as Example 1, except that the thickness ratio of the lower layer region to the upper layer region of the negative electrode active material layer, and the weight ratio (loading amount ratio) of the lower layer region to the upper layer region were changed as shown in the following Table 2.

### Example 3: Manufacture of Negative Electrode and Lithium Secondary Battery

A negative electrode and a lithium secondary battery were obtained in the same manner as Example 1, except that the thickness ratio of the lower layer region to the upper layer region of the negative electrode active material layer, and the weight ratio (loading amount ratio) of the lower layer region to the upper layer region were changed as shown in the following Table 2.

### Example 4: Manufacture of Negative Electrode and Lithium Secondary Battery

A negative electrode and a lithium secondary battery were obtained in the same manner as Example 1, except that the thickness ratio of the lower layer region to the upper layer region of the negative electrode active material layer, and the weight ratio (loading amount ratio) of the lower layer region to the upper layer region were changed as shown in the following Table 2.

### Example 5: Manufacture of Negative Electrode and Lithium Secondary Battery

First, 9.35 parts by weight of natural graphite having an average sphericity of 0.95 and 84.15 parts by weight of artificial graphite having an average sphericity of 0.9, as a first negative electrode active material, 1.0 parts by weight of carbon black as a conductive material, 4 parts by weight of styrene butadiene rubber (SBR) and 1.5 parts by weight of carboxymethyl cellulose (CMC), as a first binder, and water as a first dispersion medium were mixed to prepare a slurry for a lower layer having a solid content of 46.0%.

Next, 9.65 parts by weight of natural graphite having an average sphericity of 0.95 and 86.85 parts by weight of artificial graphite having an average sphericity of 0.9, as a second negative electrode active material, 1.0 parts by weight of carbon black as a conductive material, 1.0 parts by weight of styrene butadiene rubber (SBR) and 1.5 parts by weight of carboxymethyl cellulose (CMC), as a second binder, and water as a second dispersion medium were mixed to prepare a slurry for an upper layer having a solid content of 46.0%.

A negative electrode and a lithium secondary battery were obtained in the same manner as Example 1, except that the slurry for a lower layer and the slurry for an upper layer prepared as described above were used, and the thickness ratio of the lower layer region to the upper layer region of the negative electrode active material layer, and the weight ratio (loading amount ratio) of the lower layer region to the upper layer region were changed as shown in the following Table 2.

### Example 6: Manufacture of Negative Electrode and Lithium Secondary Battery

First, 9.35 parts by weight of natural graphite having an average sphericity of 0.95 and 84.15 parts by weight of artificial graphite having an average sphericity of 0.9, as a first negative electrode active material, 1.0 parts by weight of carbon black as a conductive material, 4 parts by weight of styrene butadiene rubber (SBR) and 1.5 parts by weight of carboxymethyl cellulose (CMC), as a first binder, and water as a first dispersion medium were mixed to prepare a slurry for a lower layer having a solid content of 46.0%.

Next, 9.72 parts by weight of natural graphite having an average sphericity of 0.95 and 87.48 parts by weight of artificial graphite having an average sphericity of 0.9, as a second negative electrode active material, 1.0 parts by weight of carbon black as a conductive material, 0.3 parts by weight of styrene butadiene rubber (SBR) and 1.5 parts by weight of carboxymethyl cellulose (CMC), as a second binder, and water as a second dispersion medium were mixed to prepare a slurry for an upper layer having a solid content of 46.0%.

A negative electrode and a lithium secondary battery were obtained in the same manner as Example 1, except that the slurry for a lower layer and the slurry for an upper layer prepared as described above were used, and the thickness ratio of the lower layer region to the upper layer region of the negative electrode active material layer, and the weight ratio (loading amount ratio) of the lower layer region to the upper layer region were changed as shown in the following Table 2.

### Example 7: Manufacture of Negative Electrode and Lithium Secondary Battery

First, 9.35 parts by weight of natural graphite having an average sphericity of 0.95 and 84.15 parts by weight of artificial graphite having an average sphericity of 0.9, as a first negative electrode active material, 1.0 parts by weight of carbon black as a conductive material, 4 parts by weight of styrene butadiene rubber (SBR) and 1.5 parts by weight of carboxymethyl cellulose (CMC), as a first binder, and water as a first dispersion medium were mixed to prepare a slurry for a lower layer having a solid content of 46.0%.

Next, 9.729 parts by weight of natural graphite having an average sphericity of 0.95 and 87.561 parts by weight of artificial graphite having an average sphericity of 0.9, as a second negative electrode active material, 1.0 parts by weight of carbon black as a conductive material, 0.21 parts by weight of styrene butadiene rubber (SBR) and 1.5 parts by weight of carboxymethyl cellulose (CMC), as a second binder, and water as a second dispersion medium were mixed to prepare a slurry for an upper layer having a solid content of 46.0%.

A negative electrode and a lithium secondary battery were obtained in the same manner as Example 1, except that the slurry for a lower layer and the slurry for an upper layer prepared as described above were used, and the thickness ratio of the lower layer region to the upper layer region of the negative electrode active material layer, and the weight ratio (loading amount ratio) of the lower layer region to the upper layer region were changed as shown in the following Table 2.

### Comparative Example 1: Manufacture of Negative Electrode and Lithium Secondary Battery

A negative electrode and a lithium secondary battery were obtained in the same manner as Example 1, except that the thickness ratio of the lower layer region to the upper layer region of the negative electrode active material layer, and the weight ratio (loading amount ratio) of the lower layer region to the upper layer region were changed as shown in the following Table 2.

### Comparative Example 2: Manufacture of Negative Electrode and Lithium Secondary Battery

A negative electrode and a lithium secondary battery were obtained in the same manner as Example 1, except that the thickness ratio of the lower layer region to the upper layer region of the negative electrode active material layer, and the weight ratio (loading amount ratio) of the lower layer region to the upper layer region were changed as shown in the following Table 2.

### Comparative Example 3: Manufacture of Negative Electrode and Lithium Secondary Battery

A negative electrode and a lithium secondary battery were obtained in the same manner as Example 1, except that the thickness ratio of the lower layer region to the upper layer region of the negative electrode active material layer, and the weight ratio (loading amount ratio) of the lower layer region to the upper layer region were changed as shown in the following Table 2.

### Comparative Example 4: Manufacture of Negative Electrode and Lithium Secondary Battery

A negative electrode and a lithium secondary battery were obtained in the same manner as Example 5, except that the thickness ratio of the lower layer region to the upper layer region of the negative electrode active material layer, and the weight ratio (loading amount ratio) of the lower layer region to the upper layer region were changed as shown in the following Table 2.

### Comparative Example 5: Manufacture of Negative Electrode and Lithium Secondary Battery

First, 9.35 parts by weight of natural graphite having an average sphericity of 0.95 and 84.15 parts by weight of artificial graphite having an average sphericity of 0.9, as a first negative electrode active material, 1.0 parts by weight of carbon black as a conductive material, 4 parts by weight of styrene butadiene rubber (SBR) and 1.5 parts by weight of carboxymethyl cellulose (CMC), as a first binder, and water as a first dispersion medium were mixed to prepare a slurry for a lower layer having a solid content of 46.0%.

Next, 9.731 parts by weight of natural graphite having an average sphericity of 0.95 and 87.579 parts by weight of artificial graphite having an average sphericity of 0.9, as a second negative electrode active material, 1.0 parts by weight of carbon black as a conductive material, 0.19 parts by weight of styrene butadiene rubber (SBR) and 1.5 parts by weight of carboxymethyl cellulose (CMC), as a second binder, and water as a second dispersion medium were mixed to prepare a slurry for an upper layer having a solid content of 46.0%.

A negative electrode and a lithium secondary battery were obtained in the same manner as Example 1, except that the slurry for a lower layer and the slurry for an upper layer prepared as described above were used, and the thickness ratio of the lower layer region to the upper layer region of the negative electrode active material layer, and the weight ratio (loading amount ratio) of the lower layer region to the upper layer region were changed as shown in the following Table 2.

Evaluation of Characteristics of Negative Electrode/Secondary Battery

(1) Evaluation of Adhesion of Negative Electrode

The adhesion of each of the negative electrodes according to Examples 1-7 and Comparative Examples 1-5 was determined. The results are shown in the following Table 2.

The method for determining the adhesion of each negative electrode is as follows.

Each of the negative electrodes was cut into a size of 20 mm×200 mm (width×length) to prepare a negative electrode sample. A double-sided adhesive tape was attached to a glass plate, and the negative electrode sample was attached thereto in such a manner that the active material layer surface of the negative electrode sample might be adhered to the adhesive tape. Then, the negative electrode sample was fixed firmly to the glass plate by pushing it with a 2 kg roller, while allowing the roller to reciprocate on the negative electrode sample 10 times. After that, the end portion of the negative electrode sample was mounted to a UTM instrument (LLOYD Instrument LF Plus), and force was applied at 900 and a rate of 300 mm/min. The force required for separating the active material layer from the current collector was measured. Herein, the test length was 5 cm, and the adhesion measurement data from the initial test to 1 cm of the test length of 5 cm were excluded, and the average of adhesion values measured over a test length of 1-5 cm was calculated and defined as the adhesion of the corresponding negative electrode.

(2) Determination of Resistance of Secondary Battery

Each of the secondary batteries according to Examples 1-7 and Comparative Examples 1-5 (width×length=4×4 cm) was charged at 1 C in a constant current (CC)/constant voltage (CV) mode to 4.25 V at a room temperature of 25° C., and the discharge resistance was calculated from the voltage after applying an electric current corresponding to 2.5 C for 30 seconds at a SOC (state-of-charge) of 50. The results are shown in the following Table 2.

TABLE 2

| | | | | | | | | Slurry | | |
|---|---|---|---|---|---|---|---|---|---|---|
| | | | | | Thickness | | | thickness | | |
| | | | | | of | | | ratio | | |
| | | Weight per unit | | | active | | | Slurry for | | |
| | | area (loading | | Weight | material | Thickness | | lower | | |
| | | amount) (g/cm²) | | ratio | layer | ratio | Coated | layer:Slurry | | |
| | | | Upper | Lower | (after | Lower | slurry | for | | |
| | | | layer/Lower | layer:Up- | drying) | layer:Up- | thickness | upper | Adhesion | Resistance |
| | | Total | layer | per layer | (μm) | per layer | (μm) | layer | (gf/20 mm) | (mohm) |
| Comp. | Upper | 400 | 200 | 1:1 | 100 | 1:1 | 130.61 | 1:1 | 22.10 | 1.56 |
| Ex. 1 | layer | | | | | | | | | |
| | Lower | | 200 | | 100 | | 131.22 | | | |
| | layer | | | | | | | | | |
| Ex. 1 | Upper | 400 | 250 | 1:1.67 | 124 | 1:1.65 | 163.27 | 1:1.66 | 22.20 | 1.52 |
| | layer | | | | | | | | | |
| | Lower | | 150 | | 75 | | 98.42 | | | |
| | layer | | | | | | | | | |
| Ex. 2 | Upper | 400 | 300 | 1:3 | 149 | 1:2.98 | 195.92 | 1:2.99 | 21.78 | 1.491 |
| | layer | | | | | | | | | |
| | Lower | | 100 | | 50 | | 65.61 | | | |
| | layer | | | | | | | | | |
| Ex. 3 | Upper | 400 | 350 | 1:7 | 174 | 1:6.96 | 228.57 | 1:6.97 | 22.00 | 1.475 |
| | layer | | | | | | | | | |
| | Lower | | 50 | | 25 | | 32.81 | | | |
| | layer | | | | | | | | | |
| Ex. 4 | Upper | 400 | 360 | 1:9 | 179 | 1:8.95 | 235.11 | 1:8.96 | 22.30 | 1.47 |
| | layer | | | | | | | | | |
| | Lower | | 40 | | 20 | | 26.24 | | | |
| | layer | | | | | | | | | |
| Comp. | Upper | 400 | 362 | 1:9.53 | 180 | 1:9.47 | 236.41 | 1:9.48 | 21.67 | 1.47 |
| Ex. 2 | layer | | | | | | | | | |
| | Lower | | 38 | | 19 | | 24.93 | | | |
| | layer | | | | | | | | | |
| Comp. | Upper | 400 | 190 | 1:0.90 | 95 | 1:0.913 | 124.08 | 1:0.90 | 22.30 | 1.572 |
| Ex. 3 | layer | | | | | | | | | |
| | Lower | | 210 | | 104 | | 137.78 | | | |
| | layer | | | | | | | | | |
| Ex. 5 | Upper | 400 | 315 | 1:3.71 | 157 | 1:3.78 | 205.40 | 1:3.67 | 31.30 | 1.465 |
| | layer | | | | | | | | | |
| | Lower | | 85 | | 42 | | 55.94 | | | |
| | layer | | | | | | | | | |
| Comp. | Upper | 400 | 190 | 1:0.90 | 95 | 1:0.913 | 123.89 | 1:0.90 | 31.10 | 1.62 |
| Ex. 4 | layer | | | | | | | | | |
| | Lower | | 210 | | 104 | | 138.21 | | | |
| | layer | | | | | | | | | |
| Ex. 6 | Upper | 400 | 250 | 1:167 | 125.0 | 1:1.68 | 166.45 | 1:1.68 | 28.4 | 1.517 |
| | layer | | | | | | | | | |
| | Lower | | 150 | | 74.2 | | 98.8 | | | |
| | layer | | | | | | | | | |
| Ex. 7 | Upper | 400 | 250 | 1:167 | 124.8 | 1:1.68 | 166.14 | 1:1.68 | 28.1 | 1.505 |
| | layer | | | | | | | | | |
| | Lower | | 150 | | 74.2 | | 98.8 | | | |
| | layer | | | | | | | | | |
| Comp. | Upper | 400 | 250 | 1:167 | 124.9 | 1:1.68 | 166.34 | 1:1.68 | 27.2 | 1.633 |
| Ex. 5 | layer | | | | | | | | | |
| | Lower | | 150 | | 74.2 | | 98.8 | | | |
| | layer | | | | | | | | | |

Referring to Table 2, it can be seen that the negative electrode satisfying a thickness ratio of the lower layer region to the upper layer region of the negative electrode active material layer of 1:1.04-1:9 and a weight ratio of the lower layer region to the upper layer region of 1:1.04-1:9 according to each of Examples 1-7 and a secondary battery using the negative electrode show a significantly reduced resistance value to provide improved resistance characteristics, and realizes improved adhesion between the negative electrode active material layer and the negative electrode current collector, as compared to Comparative Examples 1-5. Particularly, it is thought that since the binder content in the upper layer is small in the case of the negative electrode according to Comparative Example 5, the second active material particles show reduced adhesion among themselves at a partial zone of the upper layer region, thereby causing contact loss among the second active material particles having such reduced adhesion during the initial charge/discharge of the secondary battery using the negative electrode according to Comparative Example 5, resulting in an increase in resistance.

1. A negative electrode, comprising:
a negative electrode current collector; and
a negative electrode active material layer disposed on at least one surface of the negative electrode current collector, and having a lower layer region containing a first active material and a first binder, and an upper layer region disposed on the lower layer region and containing a second active material and a second binder,
wherein a weight percentage (wt %) of the first binder in the lower layer region is larger than the weight percentage (wt %) of the second binder in the upper layer region,
the lower layer region and the upper layer region have a thickness ratio of 1:1.04-1:9, and
the lower layer region and the upper layer region have a weight ratio of 1:1.04-1:9.

2. The negative electrode according to claim 1, wherein a thickness ratio of the lower layer region to the upper layer region is 1:1.65-1:8.96.

3. The negative electrode according to claim 1, wherein a weight ratio of the lower layer region to the upper layer region is 1:1.65-1:9.

4. The negative electrode according to claim 1, wherein a ratio of the weight percentage (wt %) of the first binder in the lower layer region based on the weight percentage (wt %) of the second binder in the upper layer region is 1.1-20.

5. The negative electrode according to claim 1, wherein each of the first active material and the second active material comprises artificial graphite, natural graphite, hard carbon, soft carbon, graphitized carbon fibers, graphitized mesocarbon microbeads, petroleum cokes, baked resin, carbon fibers, pyrolyzed carbon, Si, silicon oxide represented by SiOₓ (0<x≤2), lithium titanium oxide (LTO), lithium metal, or two or more thereof.

6. A method for manufacturing a negative electrode, comprising:
preparing a slurry for a lower layer containing a first active material, a first binder and a first dispersion medium, and a slurry for an upper layer containing a second active material, a second binder and a second dispersion medium;
coating the slurry for a lower layer on one surface of a negative electrode current collector to form a coated slurry for a lower layer, and coating the slurry for an upper layer on the coated slurry for a lower layer to form a coated slurry for an upper layer, at the same time or with a predetermined time interval; and
drying the coated slurry for a lower layer and the coated slurry for an upper layer at the same time to form an active material layer,
wherein a weight percentage (wt %) of the first binder in a solid content of the slurry for a lower layer is larger than a weight percentage (wt %) of the second binder in a solid content of the slurry for an upper layer,
a thickness ratio of the coated slurry for a lower layer and the coated slurry for an upper layer have is 1:1.04-1:9, and
a weight ratio of the solid content of the coated slurry for a lower layer to the solid content of the coated slurry for an upper layer is 1:1.04-1:9.

7. The method for manufacturing a negative electrode according to claim 6, wherein a thickness ratio of the coated slurry for a lower layer and the coated slurry for an upper layer is 1:1.65-1:8.96.

8. The method for manufacturing a negative electrode according to claim 6, wherein a weight ratio of the solid content of the coated slurry for a lower layer to the sold content of the coated slurry for an upper layer is 1:1.65-1:9.

9. The method for manufacturing a negative electrode according to claim 6, wherein a ratio of the weight percentage (wt %) of the first binder in the solid content of the coated slurry for a lower layer based on the weight percentage (wt %) of the second binder in the solid content of the coated slurry for an upper layer is 1.1-20.

10. A lithium secondary battery comprising the negative electrode according to claim 1.
